(19) United States
(12) Patent Application Publication
(10) Pub. No.: US 2007/0208674 A1
(43) Pub. Date: Sep. 6, 2007

(54) Printer and method for operating same

(75) Inventor: Jason R. Oliver, Rush, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/368,907

(22) Filed: Mar. 6, 2006

(51) Int. Cl. G06F 17/00

(52) U.S. Cl. 705/408

(57) ABSTRACT

A method for operating a printer. The method comprises the steps of: accessing an electronic mail server account, the account being used by the electronic mail server to store electronic mail messages directed to a particular electronic mail destination; obtaining, from the electronic mail server, any electronic mail message that is associated with print source data that can be used by the printer to provide a printable digital asset that can be used by the printer to print an image; using the print source data to provide the printable digital asset; and generating an output after the printable digital asset is provided. Wherein the print source data represents any form of data that can be used as a printable digital asset that can be used to form a printable digital asset or that indicates where such data can be obtained.

### FIELD OF THE INVENTION

The invention relates to digital image printers and methods for operating the same.

### BACKGROUND OF THE INVENTION

As the number of digital imaging devices such as digital still cameras, digital video cameras, camera enabled cellular telephones, and photo viewers increases, there is an increasingly acute need for convenient ways to obtain printed images from such devices. Of particular interest to many users of such digital imaging devices, is the ability to print images at printers that can be distant from the digital imaging device. However, current printing solutions of this type, such as printing to an internet printing protocol enabled printer or other xHTML-Print based solutions require the installation of custom software or applications on the digital imaging device. Most suppliers of digital imaging devices have preferred printing solutions which are not always compatible with particular printers. Accordingly, such suppliers typically install only custom software that is compatible with the preferred printing solution and a user of a digital imaging device who wishes to use another printing solution is typically required to install custom software for use with that solution. However, such users often find that such custom software does not exist for their device or that that it is difficult or impossible to install such custom software.

What is desired, therefore, are printers and printing methods that allow a user of a conventional digital imaging device to cause images stored thereon to be printed without using custom printing software.

### SUMMARY OF THE INVENTION

In one aspect, a method for operating a printer is provided. The method comprises the steps of: accessing an electronic mail server account, the account being used by the electronic mail server to store electronic mail messages directed to a particular electronic mail destination; obtaining, from the electronic mail server, any electronic mail message that is associated with print source data that can be used by the printer to provide a printable digital asset that can be used by the printer to print an image; using the print source data to provide the printable digital asset; and generating an output after the printable digital asset is provided. Wherein the print source data represents any form of data that can be used as a printable digital asset that can be used to form a printable digital asset or that indicates where such data can be obtained.

In another aspect, a method for operating a printer is provided. The method comprises the steps of: accessing an electronic mail server having electronic mail messages stored therein for use by the printer; locating an electronic mail message having associated print source data; downloading the located electronic mail message and print source data from the electronic mail server to the printer; and processing the downloaded electronic mail message and print source data to obtain a printable digital asset that can be used for generating a printed output.

In still another aspect, a printer is provided. The printer comprises: a printhead for printing on a receiver medium; a transport system adapted to provide relative positioning of the printhead and receiver medium during printing; a communication circuit operable to establish a communication link with an electronic mail server; and a processor operable to automatically cause the communication circuit to communicate with the remote electronic mail server; that is adapted to store electronic mail and any associated print source data directed to a particular electronic mail destination in a manner that is accessible by an authorized client; the processor further causing the communication circuit to transmit data causing the remote electronic mail server cooperate with the processor and communication system of the printer to download any electronic mail message that was directed to the particular destination and that is logically associated with print source data that can be used to provide a printable digital asset that can be used by the printer to print an image. Wherein the processor is adapted to process the electronic mail message and associated print source data to provide the printable digital asset and to automatically generate an output.

In yet another aspect, a printer is provided. The printer comprises a printhead for printing on a receiver medium; a transport system adapted to provide relative positioning of the printhead and receiver medium during printing; a communication circuit operable to send or receive data using a network; and a processor operable to cooperate with the communication circuit to communicate to receive an electronic mail message and associated print source data from the network; the processor being adapted to process the electronic mail message and associated print source data to form a printable digital asset that can be used for printing an image said processor further being adapted to generate an output after at least one of said printable digital assets is formed.

### BRIEF DESCRIPTION OF THE DRAWINGS

FIG. 1 shows one embodiment of a printer;

FIG. 2 shows a flow diagram of one embodiment of a method for operating a printer; and

FIG. 3 shows another method for operating a printer;

FIG. 4 shows a typical communication topology for an electronic mail system using a printer;

FIG. 5 shows another embodiment of a printer; and

FIG. 6 shows the use of printer 20 in the topology described above.

### DETAILED DESCRIPTION OF THE INVENTION

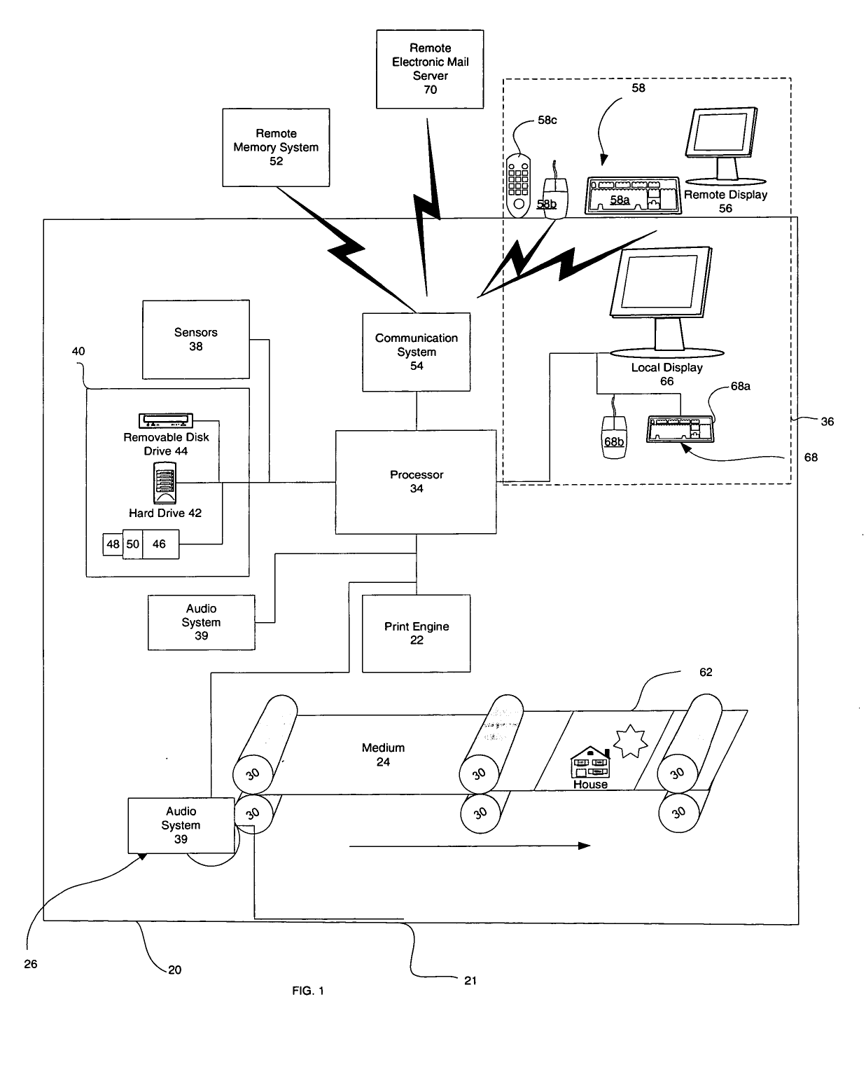

FIG. 1 shows one embodiment of a printer 20. In the embodiment of FIG. 1, printer 20 comprises a housing 21 having a print engine 22 that applies markings or otherwise forms an image on a receiver medium 24. Print engine 22 can record images on receiver medium 24 using a variety of known technologies including, but not limited to, conventional four color offset separation printing or other contact printing, silk screening, dry electrophotography such as is used in the NexPress 2100 printer sold by Eastman Kodak Company, Rochester, N.Y., USA, thermal printing technology, drop on demand ink jet technology and continuous inkjet technology. For the purpose of the following discussions, print engine 22 will be described as being of a type that generates color images. However, it will be appreciated that this is not necessary and that the claimed methods and apparatuses herein can be practiced with a print engine 22 that prints monotone images such as black and white, grayscale or sepia toned images.

A medium advance 26 is used to position receiver medium 24 and/or print engine 22 relative to each other. Medium advance 26 can comprise, for example, any number of well-known systems for moving receiver medium 24 within printer 20, including a motor 28 driving pinch rollers 30, a motorized platen roller (not shown) or other well-known systems for the movement of paper or other types of receiver medium 24.

A processor 34 operates print engine 22 and medium advance 26. Processor 34 can include, but is not limited to, a programmable digital computer, a programmable microprocessor, a programmable logic processor, a series of electronic circuits, a series of electronic circuits reduced to the form of an integrated circuit, or a series of discrete components. Processor 34 operates printer 20 based upon input signals from a user input system 36, sensors 38, a memory 40 and a communication system 54. Processor 34 can be a unitary device or it can comprise any of a combination of various components some of which may be within housing 21 and others of which may be external thereto.

User input system 36 can comprise any form of transducer or other device capable of receiving an input from a user and converting this input into a form that can be used by processor 34. For example, user input system 36 can comprise a touch screen input, a touch pad input, a 4-way switch, a 6-way switch, an 8-way switch, a stylus system, a trackball system, a joystick system, a voice recognition system, a gesture recognition system, a keyboard, a remote control or other such systems. In the embodiment shown in FIG. 1, user input system 36 includes an optional remote input 58 and a local input 68.

Sensors 38 are optional and can include light sensors and other sensors known in the art that can be used to detect conditions in the environment proximate to or within printer 20 and to convert this information into a form that can be used by processor 34 in governing operation of print engine 22 and/or other systems of printer 20. Sensors 38 can include audio sensors adapted to capture sounds. Sensors 38 can also include positioning and other sensors used internally to monitor printer operations.

Memory 40 can include conventional memory devices including solid state, magnetic, optical or other data storage devices. Memory 40 can be fixed within printer 20 or it can be removable. In the embodiment of FIG. 1, printer 20 is shown having a hard drive 42, a disk drive 44 for a removable disk such as an optical, magnetic or other disk memory (not shown) and a memory card slot 46 that holds a removable memory 48 such as a removable memory card and has a removable memory interface 50 for communicating with removable memory 48. Data including but not limited to control programs, digital images and metadata can also be stored in a remote memory system 52 that is external to printer 20 such as a personal computer, computer network or other digital system.

In the embodiment shown in FIG. 1, printer 20 has a communication system 54 that is optionally used in this embodiment to communicate with remote memory system 52, remote display 56, and remote input 58. Remote input 58 can take a variety of forms, including but not limited to, the remote keyboard 58a, remote mouse 58b or remote control handheld device 58c illustrated in FIG. 1. Remote display 56 and/or remote input 58 can communicate with communication system 54 wirelessly as illustrated or can communicate in a wired fashion.

Similarly, local input 68 can take a variety of forms. In the embodiment of FIG. 1, local input 68 is shown that includes a local keyboard 68a and a local mouse 68b. Further, in the embodiment of FIG. 1, local display 66 and local user input 68 are shown directly connected to processor 34. In an alternative embodiment, either or both of local display 66 and local user input 68 can be connected to processor 34 by way of a wired or wireless connection with communication system 54.

Communication system 54 can comprise for example, one or more optical, radio frequency, or other transducer circuits or other systems that convert image and other data into a form that can be conveyed to a remote device such as remote memory system 52 or remote display device 56 using an optical signal, radio frequency signal or other form of signal. Communication system 54 can also be used to receive a digital image and other data from a host computer or network (not shown), remote memory system 52 or remote input 58. As will be described in greater detail below, communication system 54 is adapted to communicate with a remote electronic mail server 70. Communication system 54 provides processor 34 with information and instructions from signals received thereby.

Typically, communication system 54 will be adapted to communicate with the remote electronic mail server 70 by way a communication network such as a conventional telecommunication or data transfer network such as the internet, a cellular, peer-to-peer or other form of mobile telecommunication network, a local communication network such as wired or wireless local area network or any other conventional wired or wireless data transfer system.

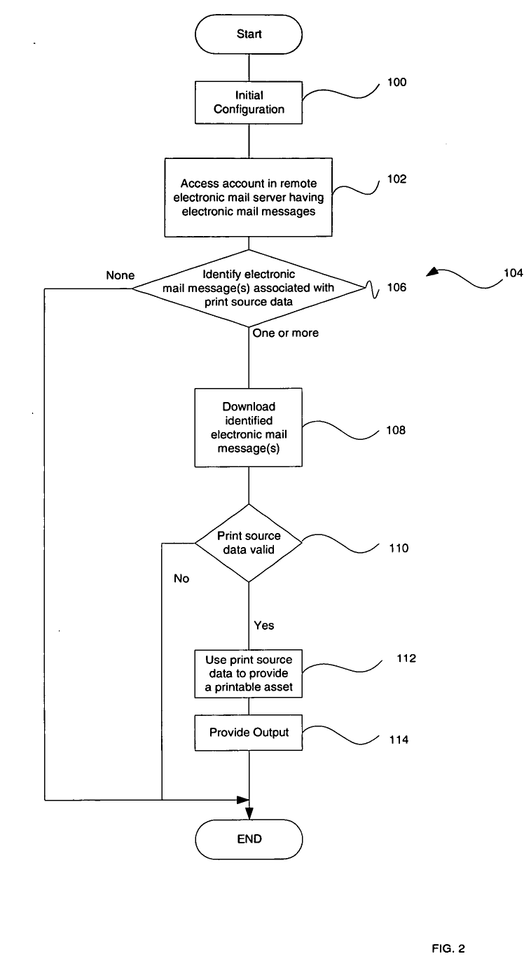

FIG. 2 shows a one embodiment of a method for operating printer 20. In the embodiment of FIG. 2, an optional initial configuration process is performed wherein identification, authentication information, and/or other information useful in establishing communication with remote electronic mail server 70 and in exchanging data with remote electronic mail server 70 can be stored in memory 40 of printer 20. Examples of such information include, but are not limited to, network addressing information that identifies electronic mail server 70, user account information, or user preferences. Where desired, the initial configuration process (step 100) can also be used to store other useful data including but not limited to: encryption data defining one or more encryption schemes that processor 34 can use during data exchange, data can be used by processor 34 to identify valid print requests and data that can be used to confirm printing instructions such as data that identifies an owner of printer 20 or some other person authorized to use printer 20. The initial configuration process (step 100) can be performed at a time of manufacture or sale of printer 20.

Alternatively, processor 34 can be programmed to allow a purchaser or other user of printer 20 to use remote user interface 58 or local interface 68 to perform the initial configuration process. In another alternative, electronic mail server 70 can be adapted to perform at least a part of the initial configuration process (step 100) by transferring data to printer 20 for storage in memory 40 after an initial communication between printer 20 and electronic mail server 70.

As shown in FIG. 2, processor 34 causes communication system 54 to access an account on a remote electronic mail server 70 (step 102). Processor 34 can cause such access to occur on a periodic basis and/or in response to a request from a user. Typically, electronic mail server 70 requires that printer 20 provide some form of identification and/or authentication before permitting processor 34 to have such access.

In the embodiment of FIGS. 1 and 2, remote electronic mail server 70 has electronic mail stored therein that is accessible using printer 20. At least some of the electronic mail stored therein is associated with print source data. Such print source data can be associated with an electronic mail message in any logical manner including attaching the print source data as an attachment to the electronic mail message and providing the print source data in a form that is in-line with the electronic mail message or otherwise embedded therewith. Such print source data can comprise any known data structure having data therein that can be used for printing. Such print source data can include, but is not limited to text data, image data, graphic data, raster data, documents in the portable document format (PDF), audio data and/or video data. Alternatively the print source data can comprise reference information that can comprise any form of information that can be used by processor 34 and/or communication system 54 to obtain any known data structure having data therein that can be used or converted into data that can be used for printing. Non-limiting examples of such reference information include a local network address, a wide area network address, or an internet address such an address that is of the type that is used with the file transfer protocol (FTP) or the HyperText Transfer Protocol (HTTP).

The print source data can also provide printing instructions either in the form of an attachment to an electronic mail message or in the form in-line data within an electronic mail message. The printing instructions can comprise directions or other information regarding the size, shape, color or quantity or other characteristics, delivery and/or payment information for an image printed by printer 20. The printing instructions can be provided in the electronic mail message or incorporated or associated with the print source data. One example of printing instructions that can be contained within the print source data includes Digital Print Order Format described at http://Panasonicjp/dc/dpof_{—}110_index.html.

In the embodiment of FIGS. 1 and 2, remote electronic mail server 70 comprises a conventional electronic mail server 70 such as an IMAP or POP server. In this embodiment, electronic mail server 70 has an electronic mail account associated with an address to which electronic mail messages can be electronically routed. Typically, remote electronic mail server 70 will store any received messages in a storage structure associated with the account.

The electronic mail account can be an integrated account defined herein as being of a type that has mail messages that are not intended to carry images for printing in addition to messages that are intended for printing. Such an integrated account can comprise a general purpose electronic mail account used principally by an account holder for conventional electronic mail services. Alternatively, the electronic mail account can comprise a dedicated account that is established generally for the sole purpose of receiving electronic mail having print source data intended for use by printer 20. Such a dedicated account can comprise, for example, an electronic mail account that is established for and is accessed exclusively by printer 20.

After access is established, processor 34 and communication system 54 cooperate to obtain, from the account, any electronic mail message that is associated with print source data (step 104). In the embodiment illustrated in FIG. 2, this is done by first identifying electronic mail messages in the accessed account that are associated with print source data (step 106) and downloading any identified electronic mail message from the accessed electronic mail account (step 108).

The identifying step (step 106) is optional and is principally intended for use with an integrated account. Identifying step 106 is typically performed without downloading each electronic mail message to printer 20. For example, after printer 20 accesses an account in electronic mail server 70, electronic mail server 70 can provide a listing of information regarding each mail message in the account from which processor 34 can identify messages associated with print source data. In another example, electronic mail server 70 can generate a list of electronic mail messages limited to those electronic mail messages having attributes that suggest that the electronic mail messages are associated with print source data. Alternatively, processor 34 can directly examine electronic mail messages stored in electronic mail server 70 to identify electronic mail messages that are associated with print source data.

The identified electronic mail messages are then downloaded (step 108). Protocols for executing such a download for remote electronic mail servers that use IMAP and POP protocols are well known. In one embodiment, processor 34 can use such protocols to download electronic mail messages in a manner that indicates that electronic mail server 70 can remove the downloaded electronic mail from storage on the server. In other embodiments, processor 34 can use such protocols to download an electronic mail message in a manner that allows downloaded electronic mail messages to be retained on electronic mail server 70 after downloading. Where this is done, identifying step 106 can include the step of identifying only electronic mail messages that have associated print source data and that have not previously been downloaded.

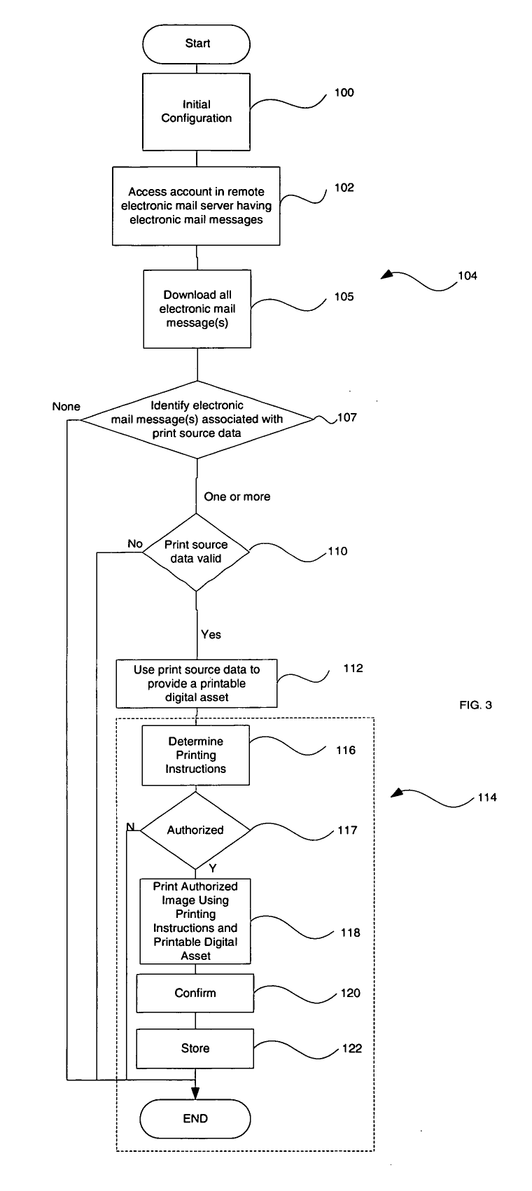

In an alternative embodiment, shown in FIG. 3, processor 34 obtains electronic mail messages from the remote electronic mail server (step 104) by way of downloading all of the electronic mail messages (step 105) and analyzes the downloaded electronic mail message (step 107) to identify whether print source data is associated with any of the downloaded electronic mail message.

Returning now to FIGS. I and 2, the validity of the print source data associated with each identified electronic mail is then tested (step 110). During such validity testing, processor 34 can determine whether the print source data that is associated with each of the identified electronic mail messages can be used to obtain at least one printable digital asset. For example, print source data can contain errors, can be in a format that is not recognizable by processor 34, can require printing in a manner that cannot be performed by printer 20 or can have other aspects that mitigate against printing. In other examples, print source data of the type that provides reference information identifying a location of data for use in printing such as a network address or worldwide web address can be inaccurate or unusable. When invalid print source data is found, processor 34 can omit or delay further action with respect to a mail message (step 110).

The print source data is then used to obtain a printable digital asset (step 112). For the purposes of this disclosure, a printable digital asset can include any form of data that can be used by processor 34 to render a printed output on a receiver medium. Where the print source data comprises digital image data, processor 34 can obtain the printable digital asset by converting the digital image data into a form that can be used for printing or by simply determining that the printable digital asset is already in a form that can be used for printing. Where the print source data comprises reference information, processor 34 and communication system 54 can cooperate to use the reference information to access a remote device from which the digital data representing the printable digital asset can be obtained and can perform any necessary processing to convert the data so obtained into a form that can be used for printing.

An output is then generated (step 1 14) after the printable digital asset is provided. The output step can comprise printing image 62 based upon the print source data. The output can also comprise the generation of a human detectible signal indicating that printer 20 has received a print job and is prepared to print or an output indicating that printer 20 has received a print job and is not prepared to print such as when printer 20 is out of a printing consumable. In this regard such a human detectible output can generate a human detectable signal providing such indications. On example of a human detectable output can comprise an image presented on a display such as a local display 66, or a sound generated by an audio output system 39 such as an amplifier (not shown) and speaker arrangement (not shown). Other known human detectable outputs can also be used such as tactile feedback generating systems.

In the embodiment of FIG. 3, the output comprises a printed image. The printing of such an image involves determining printing instructions for each valid printable digital asset (step 116) and printing an image based upon the determined printing instructions and the printable digital asset (step 118). The printing instructions can be determined based upon data that is associated with the electronic mail or with the printable digital asset. For example, the electronic mail message can contain digital data that identifies a type of image to be printed, a format for the printing, a donor type, a receiver type, a print quantity, a print size, a time of printing and/or any other characteristics that might be useful to processor 34 in determining when or how to print using the digital assets obtained using the data in the electronic mail message. Similar information can also be obtained from digital metadata that is associated with the printable digital asset including but not limited to a Digital Print Order file format described at http://panasonicjp/dc/dpof_{—}110/white_e.htm. The printable digital asset can contain, for example, any of image data, text data, graphical data, audio data and video data.

Another way in which printing instructions can be determined (step 116) is by way of accessing printing preference data that has been programmed in processor 34 or that has been stored in memory 40. Such preprogrammed or stored information can provide rules for printing that are to be applied when the electronic mail or printable digital asset are not associated with explicit printing instructions or when the electronic mail, print source data or digital asset is only associated with selected printing instructions. Further, the printing preference data can be used to establish rules for printing that are intended to override instructions associated with an electronic mail message, print source data or a printable digital asset. In still another embodiment, printing instructions can be obtained by way of user input system 36.

In the embodiment of FIG. 2, processor 34 is adapted to automatically print an image or make some other output when printable assets are provided. However, in other embodiments such as the embodiment illustrated in FIG. 3, an optional authorization step (step 117) is provided for determining that a printable digital asset is authorized for printing. This can be done in an automatic manner, a manual manner or in a semi-automatic manner.

There are a variety of ways to automatically determine that the printing of a printable asset that is associated with an electronic mail message is authorized for printing. In one embodiment, this is done by way of searching the electronic mail message for appropriate markers that indicate that the electronic mail message was transmitted by a sender authorized to print images using printer 20. For example, as discussed above, during a configuration process, configuration data can be stored in printer 20 that processor 34 can use to determine whether an e-mail stored in electronic mail server 70 constitutes an authorized print request. This data can comprise a code word, key word or other data structure that is incorporated by the sender in the electronic mail or print source data and that processor 34 can identify as constituting a marker of an authorized print request.

Alternatively, a source identifier, such as an electronic mail return address that identifies a source of an electronic mail message, can be used by processor 34 to identify electronic mail messages that are authorized for printing.

Typically, electronic mail that is not authorized will not be printed. It will be appreciated that this optional feature helps to protect against the possibility of printing based upon a printable source data from an unsolicited electronic mail message.

In another embodiment, the step of authorizing printing (step 117) can be performed using an interactive component. Where this is done, an output can be generated indicating that printer 20 has printable digital assets ready for printing. In one embodiment of the type, processor 34 can withhold printing until the user confirms that at least one of the printable digital assets is to be printed. Local display 66 and local input 68 can be used for this purpose, as can remote display 56 and remote input 58. When processor 34 receives such a confirmation, processor 34 can generate an output based upon the at least one recognizable asset. Alternatively, processor 34 can transmit an electronic mail message or other electronic message to a recipient person or service that has authority to authorize such printing. This recipient person can the authorize or reject the print request by way of a reply to the request.

In one example of a semi-automatic process, processor 34 can rely upon a mix of both automatic and manual modes of authorization. For example, automatic authorization tests can be applied first and manual authorization can be used when automatic authorization fails. Other combinations of automatic and manual authorization can be used. Typically, unauthorized printable digital assets will not be used for printing.

As is also illustrated in FIG. 3, processor 34 can optionally be adapted to perform a confirmation process (step 120) wherein processor 34 provides an indication that print source data from an electronic mail message has been printed or some other output is generated. For example, processor 34 can extract an address for a person or other sender of the electronic mail message and can transmit a response to the sender indicating that the printer has received the electronic mail message and/or indicating when an output has been generated.

FIG. 3 also illustrates another optional step (step 122) of recording information representing the appearance of the printable digital asset on a memory, an optical disk, magnetic disk, solid-state memory, a removable memory, or remote memory system 52. This information can comprise data constituting the printable digital asset image data from an image from which the printable digital asset was obtained, or modified versions of such data such as downsampled, monochrome, or compressed versions of such data. This step can be used to maintain an electronic or other copy of images printed by printer 20 for archival purposes.

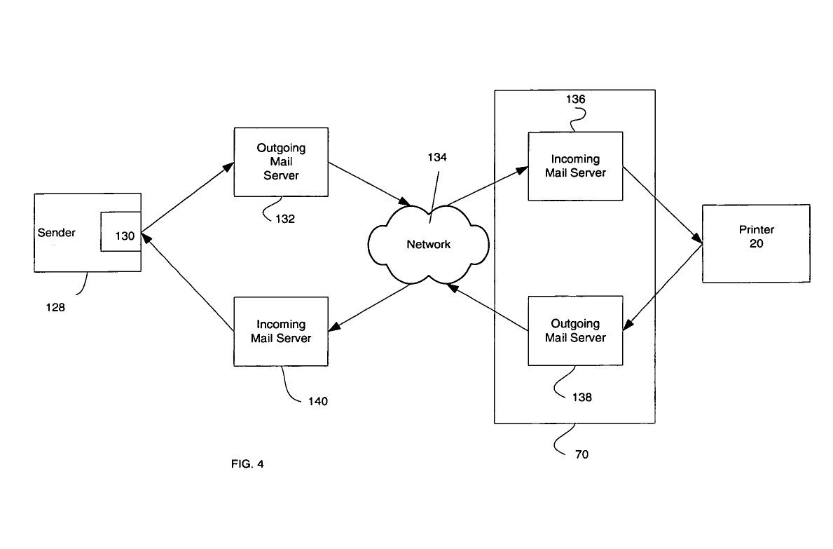

FIG. 4 shows a typical communication topology for an electronic mail system using printer 20. As is shown in FIG. 4, a sender 128 instructs a sender client 130 such as a pop client or other electronic mail client, or a proxy service to transmit an electronic mail message associated with print source data to an account at an electronic mail server 70. When this occurs, the electronic mail message associated with the print source data is provided to an outgoing mail server system 132 that packages and directs the electronic mail message to a network 134 such as a local or wide area network, the internet or a wired or wireless telecommunication network that can deliver the electronic mail message to an incoming mail server system 136 at electronic mail server 70. The incoming mail server system 136 processes the incoming electronic mail and stores it so that an account holder will have access thereto. Printer 20 accesses such electronic mail as is generally described above with respect to FIGS. 3 and 4.

Where printer 20 is adapted to perform steps such as performing print authorization (step 117) or transmitting a confirmation (step 120), printer 20 can send information to an outgoing mail server system 138 at electronic mail server 70 that packages and directs the electronic mail message to network 134 for delivery to incoming mail server 140 which then stores such mail messages or provides them to sender 128.

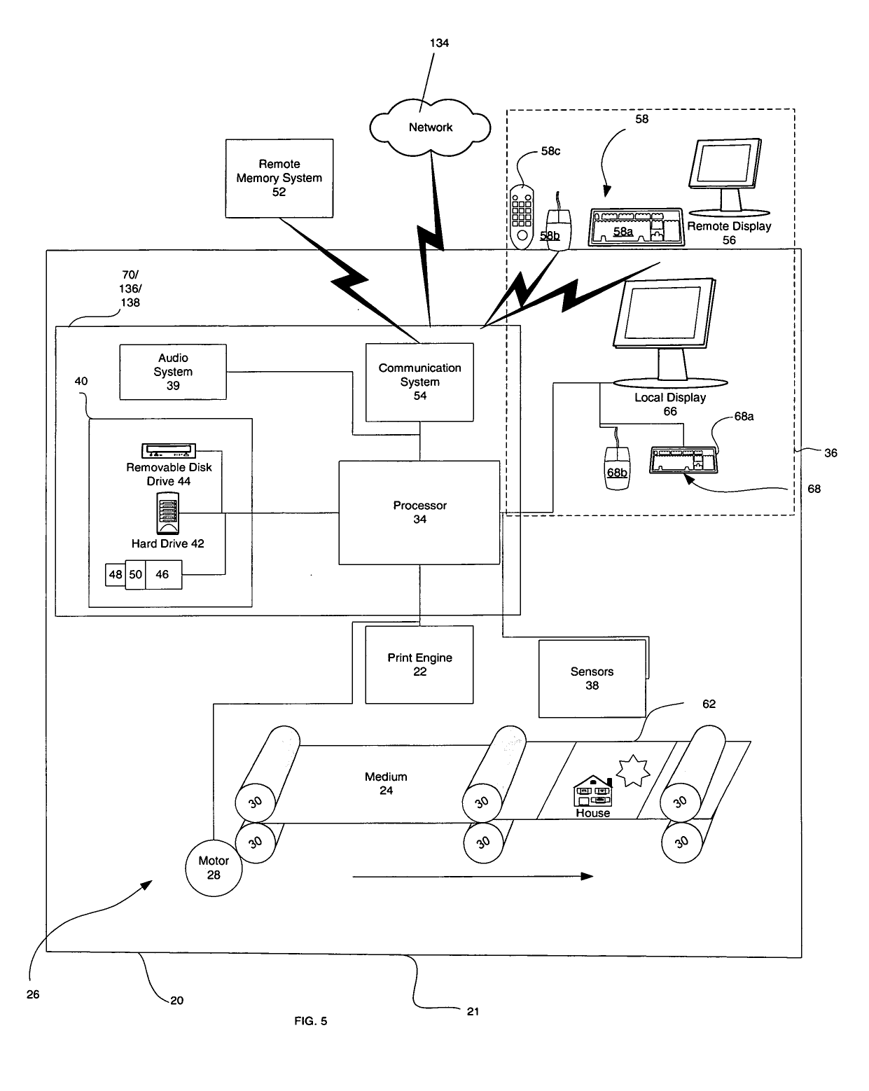

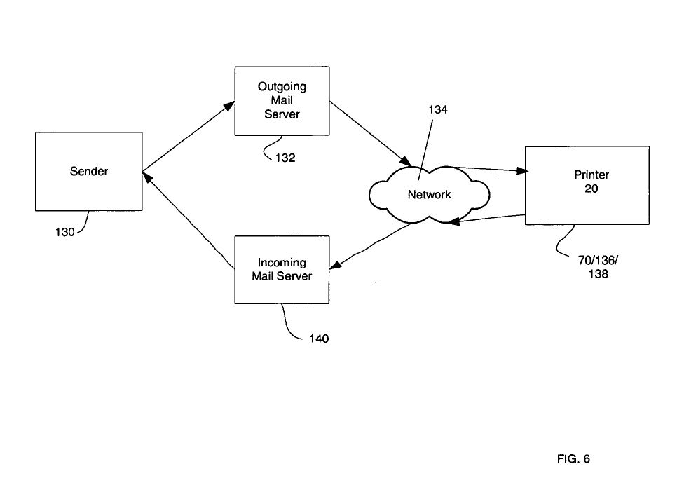

FIG. 5 shows another embodiment of a printer 20 and FIG. 6 shows the use of printer 20 in the topology described above. In particular as is shown in the embodiment of FIG. 5, printer 20 has a processor 34, memory 40 and communication system 54 that are programmed or otherwise adapted to connect to network 134 and, as shown in FIG. 6 to act as an incoming mail server 136 and as an outgoing mail server 138.

The invention has been described in detail with particular reference to certain preferred embodiments thereof, but it will be understood that variations and modifications can be effected within the spirit and scope of the invention.

### Parts List

20 printer
21 housing
22 print engine
24 receiver medium
26 medium advance
28 motor
30 pinch roller
34 processor
36 user input system
38 sensors
40 memory
42 hard drive
44 disk drive
46 memory card slot
48 removable memory
50 removable memory interface
52 remote memory system
54 communication system
56 remote display device
58 remote input
58a keyboard
58b mouse
58c remote control handheld device
62 image
66 local display device
68 local input
68a keyboard
68b mouse
70 remote electronic mail server
100 initial configuration step
102 access remote electronic mail server step
105 download all electronic mail messages step
104 obtain electronic mail messages associated with print source data step
107 analyzes downloaded electronic mail messages associated with print source data step
106 identify electronic mail messages associated with print source data step
108 download identified electronic mail messages step
110 test validity of print source data step
112 used print source data to provide printable digital asset step
114 generate output step
116 determine printing instructions step
117 authorization for printing determining step
118 print authorized image using printing instructions and printable digital asset step
120 confirmation step
122 record information step
128 sender
130 sender client
132 outgoing mail server
134 network
136 incoming mail server
138 outgoing mail server
140 incoming mail server

1. A method for operating a printer, the method comprising the steps of:
accessing an electronic mail server account, said account being used by the electronic mail server to store electronic mail messages directed to a particular electronic mail destination;
obtaining, from the electronic mail server, any electronic mail message that is associated with print source data that can be used by the printer to provide a printable digital asset that can be used by the printer to print an image;
using the print source data to provide the printable digital asset; and
generating an output after the printable digital asset is provided;
wherein said print source data represents any form of data that can be used as a printable digital assets that can be used to form a printable digital asset or that indicates where such data can be obtained.

2. The method of claim 1, further comprising the step of automatically generating a printed output based upon the print source data.

3. The method of claim 2, wherein the step of automatically generating a printed output based upon the print source data comprises generating said printed output in a manner that is further based at least in part upon the content of an electronic mail message.

4. The method of claim 1, wherein the step of generating an output comprises generating a signal indicating that the printer has printable digital assets available for printing, and further comprising the steps of receiving a selection of at least one of the printable digital assets and generating an output based upon each selected one of the printable digital assets.

5. The method of claim 1, wherein the output comprises a printed image.

6. The method of claim 5, further comprising the steps of recording information representing the printable digital asset on one of an archival memory, an optical disk, a magnetic disk, a semi-conductor memory, a remote memory or an external storage device.

7. The method of claim 1, wherein the printable digital asset comprises at least one of image data, text data, graphical data, audio data, video data, any combination of image data, text data, graphical data, audio data, video data or data that can be used to locate a memory having such data stored therein.

8. The method of claim 1, further comprising the steps of extracting an address for a device that has sent the electronic mail message having print source data to the remote server and transmitting a confirmatory response directed to the extracted address when an output has been generated.

9. A method for operating a printer, the method comprising the steps of:
accessing an electronic mail server having electronic mail messages stored therein for use by the printer;
locating an electronic mail message having associated print source data;
downloading the located electronic mail message and print source data from the electronic mail server to the printer; and
processing the downloaded electronic mail message and print source data to obtain a printable digital asset that can be used for generating a printed output.

10. The method of claim 9, further comprising the step of automatically generating a printed output of the printable digital asset.

11. The method of claim 9, further comprising the steps of generating an output indicating that the printer has printable digital assets available for printing, receiving a selection of at least one of the printable digital assets and generating an output based upon the at least one printable digital asset.

12. The method of claim 1, wherein the output comprises a printed image, and at least one of a recording of information representing the appearance of the printable digital asset, said information being recorded on an archival memory, an optical disk, a magnetic disk, a semi-conductor memory or a remote storage device.

13. The method of claim 9, further comprising the steps transmitting a response to an authorizing person or service requesting authorization for printing an image based upon a print source data and printing an image based upon the print source data when an authorization for printing is received from the authorizing person or service.

14. A printer comprising:
a printhead for printing on a receiver medium;
a transport system adapted to provide relative positioning of the printhead and receiver medium during printing;
a communication circuit operable to establish a communication link with an electronic mail server; and
a processor operable to automatically cause the communication circuit to communicate with the remote electronic mail server; that is adapted to store electronic mail and any associated print source data directed to a particular electronic mail destination in a manner that is accessible by an authorized client;
said processor further causing the communication circuit to transmit data causing the remote electronic mail server cooperate with the processor and communication system of the printer to download any electronic mail message that was directed to the particular destination and that is logically associated with print source data that can be used to provide a printable digital asset that can be used by the printer to print an image;
wherein said processor is adapted to process the electronic mail message and associated print source data to provide the printable digital asset and to automatically generate an output.

15. The printer of claim 14, wherein said processor is further operable to automatically generate a printed output for each printable digital asset.

16. The printer of claim 14, further comprising an output system generating a human detectable output indicating that a printable digital asset available for printing and a user input capable of receiving a user indication of whether to print the printable digital asset and wherein said processor is further operable to receive a selection the recognizable asset and to cause the printable digital asset to be used to print an image.

17. A printer comprising:
a printhead for printing on a receiver medium;
a transport system adapted to provide relative positioning of the printhead and receiver medium during printing;
a communication circuit operable to send or receive data using a network; and
a processor operable to cooperate with the communication circuit to communicate to receive an electronic mail message and associated print source data from the network; said processor being adapted to process the electronic mail message and associated print source data to form a printable digital asset that can be used for printing an image said processor further being adapted to generate an output after at least one of said printable digital assets is formed.

18. The printer of claim 17, wherein said output comprises a printed output based upon the printable digital asset.

19. The printer of claim 17, further comprising a human detectable output and wherein said processor is further adapted to cause the human detectable output to generate an output signal to indicate that the printer has a printable digital asset available for printing or that the printer has a printable digital asset available for printing but is lacking necessary consumables.

20. The printer of claim 17, wherein the processor is further operable to extract an address for a device that sent the electronic mail message and to cause the communication circuit to transmit a response indicating when an output has been generated.

21. The printer of claim 17, wherein said processor is adapted to detect data associated with the electronic mail message, the print source data, or the printable digital data that said processor can use as a basis for authorizing the printing of an image.
